(19) United States
(12) Patent Application Publication
(10) Pub. No.: US 2006/0221494 A1
(43) Pub. Date: Oct. 5, 2006

(54) Disk device

(75) Inventors: Satoru Katsumata, Musashino-shi (JP); Masayuki Takagishi, Kunitachi-shi (JP); Yoichiro Tanaka, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/387,985

(22) Filed: Mar. 24, 2006

(30) Foreign Application Priority Data
Mar. 31, 2005 (JP) 2005-104427

(51) Int. Cl. G11B 17/00

(52) U.S. Cl. 360/97.01

(57) ABSTRACT

According to one embodiment, a case of a magnetic disk device has a sheet-shaped base with an open upper surface formed of a soft magnetic material, and a sheet-shaped top cover with an open upper surface formed of a soft magnetic material and attached to the base. A disk-shaped recording medium arranged in the case comprises a substrate, a soft magnetic backing layer formed on the substrate, and a magnetic recording layer formed by being overlapped on the soft magnetic backing layer and having perpendicular magnetic anisotropy. The base is formed in a thickness of 0.5 mm or more and the top cover is formed in a thickness of 0.25 mm or more, respectively. The base and the top cover have a relative permeability of 700 or more and a saturation flux density of 1.4 (T) or more.

### CROSS-REFERENCE TO RELATED APPLICATIONS

This application is based upon and claims the benefit of priority from Japanese Patent Application No. 2005-104427, filed Mar. 31, 2005, the entire contents of which are incorporated herein by reference.

### BACKGROUND

1. Field

One embodiment of the present invention relates to a disk device, and more particularly, to a disk device using a recording medium employing a perpendicular magnetic recording method.

2. Description of the Related Art

A disk device, for example, a magnetic disk device includes a rectangular box-shaped case in which accommodated are a magnetic disk as a magnetic recording medium, a spindle motor as drive means for supporting and rotating the magnetic disk, a plurality of magnetic heads for writing and reading out information to and from the magnetic disk, a head actuator for movably supporting the magnetic heads with respect to the magnetic disk, a voice coil motor for rotating and positioning the head actuator, a substrate unit having an IC head etc., and the like.

As disclosed in, for example, Jpn. Pat. there is provided a magnetic disk device formed in a thin card shape so that it can be inserted into a card slot of, for example, a personal computer. Since the card-shaped magnetic disk device must be formed thinner and smaller than a conventional magnetic disk device, various components are mounted on a sheet-shaped base as well as a sheet-shaped top cover is attached to the base. Further, a printed circuit board is provided on the back surface of the base, and an I/F (interface) connector on the printed circuit board is positioned and held by a dedicated fixing member arranged to a support frame.

Further, recently, a perpendicular magnetic recording method is under development to increase a recording density. A magnetic disk device to which the perpendicular magnetic recording method is applied ordinarily includes a head disk assembly having a single magnetic pole head and a two-layered disk-shaped recording medium. The magnetic disk device is liable to be affected by disturbance of magnetic field from the outside, and a phenomenon that data recorded on the disk-shaped recording medium is deleted by the disturbance of magnetic field. Thus, the magnetic disk device using the perpendicular magnetic recording method is required to more improve a shield function to an external magnetic field than a magnetic disk device using a conventional in-plane magnetic recording method. To fulfill the requirement, in the disk device disclosed in Jpn. Pat. Appln. KOKAI Publication No. 2003-77266, a shield function is improved by winding a tape-shaped or foil-like magnetic shield member around the upper surface, the lower surface, and the side surfaces of a case, in particular, in a region confronting the moving range of magnetic heads.

However, when the tape-shaped or foil-like magnetic shield member is wound around the outside surface of a case of a card-shaped magnetic disk device the reduction in thickness and size of which is required, the thickness of the device is increased in its entirety and prevents the reduction in thickness of the device. Further, when the magnetic shield member is wound, the number of parts is increased as well as it becomes troublesome to manufacture and assemble the device, and the cost thereof is increased.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing an upper surface of a hard disk drive (hereinafter, referred to as HDD) according to an embodiment of the present invention;

FIG. 2 is a plan view of the HDD from which a top cover is removed;

FIG. 3 is an exploded perspective view of the HDD;

FIG. 4 is a sectional view showing abutment portions of a base and the top cover of the HDD;

FIG. 5 is a view schematically showing a magnetic disk and a magnetic head of the HDD;

FIG. 6 is a graph showing the relation between a relative permeability and a leakage magnetic field of the case;

FIG. 7 is a graph showing the relation between a saturation flux density and a leakage magnetic field of the case; and

FIG. 8 is a view showing a comparison of leakage magnetic field strength of a 1.8 inch magnetic disk device employing an in-plane recording method with leakage magnetic field strength of the HDD according to the embodiment.

### DETAILED DESCRIPTION

Various embodiments according to the invention will be described hereinafter with reference to the accompanying drawings. In general, according to one embodiment of the invention, a disc device comprises: a case having a sheet-shaped base with an open upper surface formed of a soft magnetic material and a sheet-shaped top cover with an open upper surface formed of a soft magnetic material and attached to the base; a disk-shaped recording medium which includes a substrate, a soft magnetic backing layer formed on the substrate, and a magnetic recording layer formed by being overlapped on the soft magnetic backing layer and having perpendicular magnetic anisotropy, the recording medium being arranged in the case; and a mechanical unit including a head which carries out an information processing to the recording medium, a head actuator which supports the head, and a drive motor which supports and rotates the recording medium, the mechanical unit being arranged on the base, the base having a thickness of 0.5 mm or more and the top cover having a thickness of 0.25 mm or more, respectively, and the base and the top cover having a relative permeability of 700 or more and a saturation flux density of 1.4 (T) or more.

An embodiment in which the present invention is applied to a HDD will be described in detail with reference to the drawings.

As shown in FIGS. 1 to 3, the HDD is formed in a card shape and arranged according to, for example, a PC card type standard. More specifically, the HDD has a rectangular sheet-shaped base 10 that has a recessed portion in which various members described later are mounted except the peripheral edge thereof, and an open upper surface. The HDD has a sheet-shaped top cover 12 for closing the upper surface of the base 10, a printed circuit board 14 provided on the back surface of the base 10, and a bottom cover 15 covering the back surfaces of the printed circuit board 14 and the base 10, and the HDD is formed in a card shape in its entirety by laminating these components. The base 10, the top cover 12, and the bottom cover 15 constitute a flat rectangular case 11.

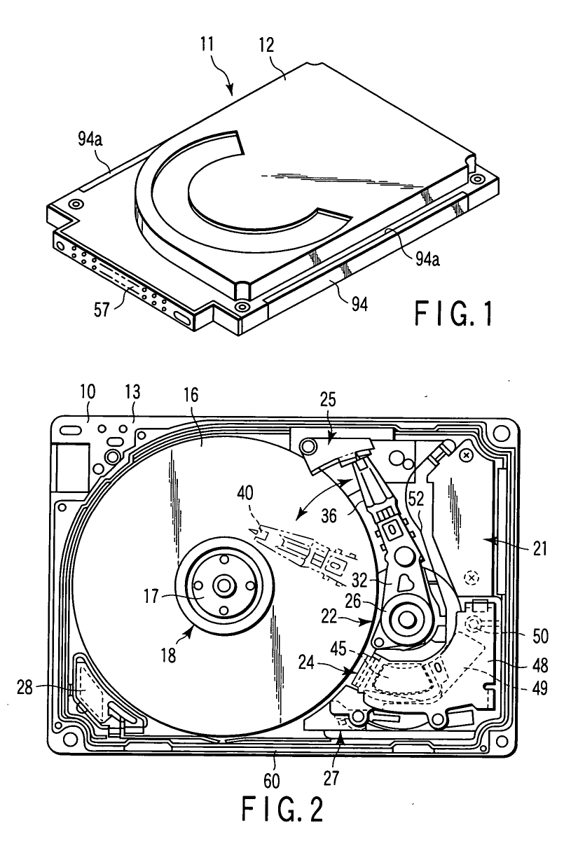

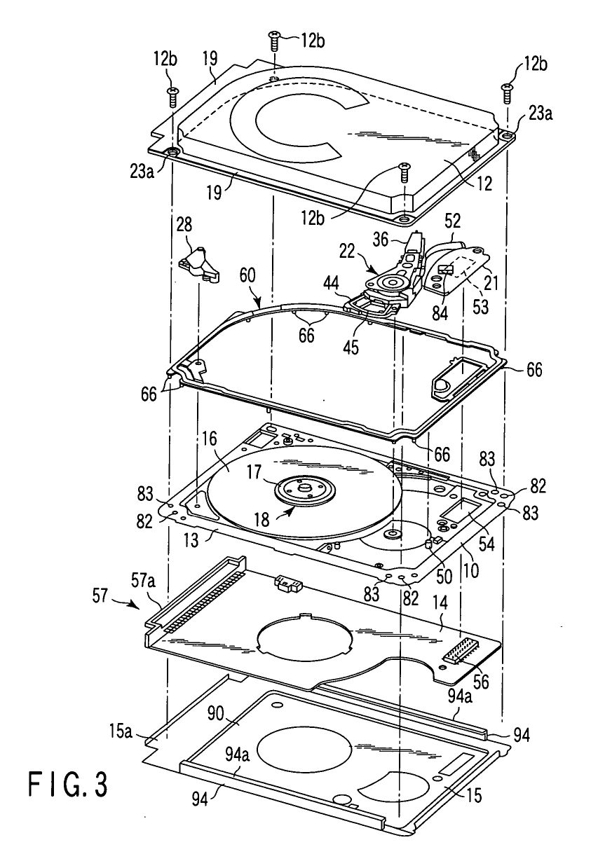

As shown in FIGS. 2 and 3, a 1.8 inch magnetic disk 16 acting as an information recording medium and a mechanical unit are arranged in the recessed portion of the base 10. The mechanical unit includes: a spindle motor 18 as a drive motor for supporting and rotating the magnetic disk; a plurality of magnetic heads 40 which write and read out information to and from the magnetic disk; a head actuator 22 for movably supporting the magnetic heads 40 with respect to the magnetic disk 16; a voice coil motor (hereinafter, referred to as VCM) 24 for rotating and positioning the head actuator 22; a ramp load mechanism 25 for keeping the magnetic heads 40 at positions spaced apart from the magnetic disk 16 when the magnetic heads 40 move to the outermost periphery of the magnetic disk 16; and an inertial latch mechanism 27 for holding the head actuator 22 at an evacuating position. A substrate unit 21 having a head IC and the like and a pack-shaped air filter 28 are arranged on the base 10.

The base 10 is formed by press molding a soft magnetic material, for example, an iron material such as a cold rolling carbon steel sheet (SPCC), and an approximately flat abutment portion 13 is formed around the peripheral edge of the base 10. A plurality of threaded holes 82, into which screws for fixing the top cover 12 are to be screwed, and a plurality of positioning holes 83, which position a gasket 60 to be described later, are formed in the abutment portion 13 of the base 10.

As shown in FIGS. 2 and 3, the spindle motor 18 is mounted in the recessed portion of the base 10. The magnetic disk 16 is fitted on a hub (not shown) of the spindle motor 18 and fixed to the hub by a damper 17. With this arrangement, the magnetic disk 16 is rotated by the spindle motor 18 at a predetermined speed.

The head actuator 22 includes: a bearing assembly 26 fixed to the base 10; two arms 32 extending from the bearing assembly 26; magnetic head assemblies 36 extending from the extreme ends of the two arms 32; and a support frame 44 that extends from the bearing assembly 26 in a direction opposite to the arms 32 as well as supports a voice coil 45. The magnetic head assemblies 36 include slender sheet-shaped suspensions and the magnetic heads 40 fixed to the extreme ends of the suspensions through not shown gimbal portions.

When the head actuator 22 arranged actual data side is assembled to the base 10, the magnetic disk 16 is interposed between the two arms 32. A pair of magnetic heads 40 confront the upper and lower surfaces of the magnetic disk 16. A predetermined head load is applied to the magnetic heads 40 toward the surfaces of the magnetic disk by the spring force of the suspensions.

The VCM 24 for rotating the head actuator 22 includes: the voice coil 45 fixed to a support frame 44 of head actuator 22; an upper yoke 48 arranged on the base 10 to face the voice coil 45; and a magnet 49 fixed on the inner surface of the upper yoke 48 and opposing the voice coil 45. The base 10 composed of the soft magnetic material also acts as a lower yoke of the VCM 24.

Energization of the voice coil 45 causes the head actuator 22 to turn between an evacuating position shown by a solid line in FIG. 2 and an actuating position on the magnetic disk 16, and the magnetic heads 40 are positioned on desired tracks of the magnetic disk 16 at the actuating position. The head actuator 22 is prevented from being excessively turned beyond the evacuating position by a stopper pin 50 standing on the base 10.

The magnetic heads 40 are electrically connected to the substrate unit 21 through a flexible cable 52. The substrate unit 21 is composed of a flexible printed circuit board and has a connector 53 mounted on the bottom thereof to connect the substrate unit 21 to the printed circuit board 14. The substrate unit 21 is fixed to the base 10 by screws, and the connector 53 confronts a rectangular signal line insertion opening 54 formed to the base 10. A shock sensor 84 is mounted on the upper surface of the substrate unit 21 to detect a shock acting on the HDD.

As shown in FIG. 5, the magnetic disk 16 has such a structure that a soft magnetic backing layer 72 called a soft magnetic under layer and a magnetized recording layer 73 with perpendicular magnetic anisotropy are sequentially laminated on each of the surfaces of a substrate 70 composed of a non-magnetic member formed in a disk shape and a protective layer 74 is further formed thereon.

The magnetic head 40 is arranged as a single magnetic pole head and includes a main magnetic pole 75 for applying a recording magnetic field to the magnetic disk 16 and a return yoke 76 acting as a flux return path. A recording coil 77 is wound around the main magnetic pole 75 to excite the main magnetic pole 75 when a signal is written to the magnetic disk 16. A read head reproducing element 78 is arranged adjacent to the return yoke 76 to read out a signal from the magnetic disk 16.

As shown in FIG. 3, the printed circuit board 14 arranged on the back surface of the base 10 is formed in a rectangular shape slightly smaller than the base 10. A connector 56 is mounted on the printed circuit board 14 and connected to a connector 53 arranged on the substrate unit 21 in the base 10 through the signal line insertion opening 54 of the base 10.

An I/F connector 57 is connected to an end of the printed circuit board 14 in a lengthwise direction to connect the HDD to external equipment. The I/F connector 57 has a flat rectangular main body 57a that is located along an edge of the printed circuit board 14 in the lengthwise direction as well as projects from the printed circuit board 14 in parallel with it. A multiplicity of lead wires extending from the main body 57a are soldered to the printed circuit board 14. When the printed circuit board 14 is arranged on the back surface of the base 10, the I/F connector 57 is located spaced apart from the base 10.

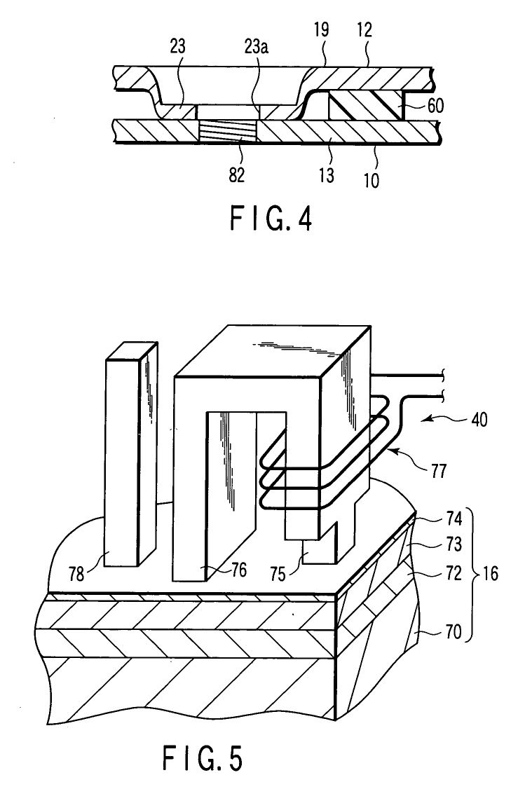

The upper surface of the base 10 on which the various components are mounted is closed by the top cover 12 fixed to the base 10 by screws. As shown in FIGS. 1 and 2, the top cover 12 is formed in a rectangular shape having a size corresponding to the base 10. The top cover 12 is formed by press molding a soft magnetic material, for example, an iron material such as a cold rolled carbon steel sheet, and the like, and an approximately flat abutment portion 19 is formed around the peripheral edge of the top cover 12. As shown in FIGS. 3 and 4, a plurality of projections 23 are formed to the abutment portion 19 of the top cover 12. The projections 23 are located to oppose the threaded holes 82 of the base 10 as well as project toward a base side. Through holes 23a are formed to the extreme ends of the projections 23.

The top cover 12 is fixed to the base 10 by screws 12b screwed into the threaded holes 82 of the base 10 through the through holes 23a. In this state, the abutment portion 13 of the base 10 confronts the abutment portion 19 of the top cover 12, and the projections 23 are abutted against the abutment portion 13 of the base 10. As described later, when the gasket 60 is sandwiched between the base 10 and the top cover 12, the projecting heights of the projections 23 are set to 1 mm or less. Further, when no gasket is used, the projecting heights of the projections 23 are set to 0 mm, thereby the abutment portion 13 of the base 10 comes into intimate contact with the abutment portion 19 of the top cover 12 in the entire regions thereof so that they are electrically and magnetically conducted with each other. Further, to improve air tightness, the widths of the abutment portions 13, 19 of the base 10 and the top cover 12 are formed larger than the thicknesses of the base 10 and the top cover 12.

In the embodiment, the gasket 60 is sandwiched between the abutment portion 13 of the base 10 and the abutment portion 19 of the top cover 12 to keep air tightness in the base 10. As shown in FIG. 3, the gasket 60 is formed in a rectangular frame shape in correspondence to the abutment portion 13 of the base 10. The gasket 60 is formed by sandwiching a thin metal or resin sheet between gasket members composed of, for example, rubber or the like from above and below them. A plurality of positioning projections 66, which project toward the base 10 side, are formed to the gasket 60 integrally therewith at a plurality of positions. The gasket 60 is arranged such that it is located at a predetermined position with respect to the abutment portion 13 by engaging the positioning projections 66 with the plurality of positioning holes 83 formed to the abutment portion 13 of the base 10. When the top cover 12 is fixed to the base 10 by the screws, the gasket 60 is sandwiched between the abutment portion 13 of the base 10 and the abutment portion 19 of the top cover 12 and seals between the abutted portions airtightly.

As shown in FIG. 3, the bottom cover 15, which covers the back surfaces of the base 10 and the printed circuit board 14, is formed by press molding a soft magnetic material, for example, an iron material such as a cold rolled carbon steel sheet (SPCC), and the like and has an approximately rectangular shape corresponding to the base 10. When the back surfaces of the base 10 and the printed circuit board 14 are covered with the bottom cover 15, an end of the bottom cover 15 in a lengthwise direction projects from the base 10 and constitutes a connector support portion 15a. The connector support portion 15a confronts the back surface of the I/F connector 57 as well as is formed in the approximately same size as the main body 57a of the I/F connector 57.

Side walls 94 are formed integrally with the long sides of the bottom cover 15 except the connector support portion 15a thereof. The side walls 94 extend vertically with respect to the bottom cover 15 as well as the extending end 94a of each of them is bent at right angles toward the other of the side walls 94.

The bottom cover 15 arranged as described above is arranged on the back surface of the printed circuit board 14 so as to overlap it and attached to the base 10 and top cover 12 by engaging the extending ends 94a of the side walls 94 with the upper surface of the abutment portion 19 of the top cover 12 as shown in FIG. 1. As described above, both the side walls 94 of the bottom cover 15 are formed such that the cross sections thereof are made to an approximately U-shape, and the abutment portions 13, 19 of the base 10 and the top cover 12 are simultaneously sandwiched by the side walls 94 from the outside and engaged with each other. As a result, the strength of the device can be increased in its entirety, and the bottom cover 15 can be fixed without using screws and dedicated support members. At the same time, an influence due to external magnetic noise and electric field can be reduced by covering the overall side walls of the HDD with the side walls 94 of the bottom cover 15.

In the HDD arranged as described above, the thickness of the top cover 12 is set to 0.5 mm or less and the thickness of the base 10 is set to 1.0 mm or less because they are restricted by the thickness of the HDD, the heights of the parts accommodated in the HDD, a G height as a gap between the magnetic heads 40 and the magnetic disk 16, and the like. It is preferable that the thickness of the top cover 12 be set to 0.25 mm or more and the thickness of the base 10 be set to 0.5 mm or more due to the restriction of strength.

When the thickness of the top cover 12 is set to 0.25 mm and the thickness of the base 10 is set to 0.5 mm, a magnetic shield effect is most weakened. In this case, when the top cover 12 formed of a SUS 430 is combined with the base 10 formed of SPCC, there is a possibility that data recorded on the magnetic disk 16 may be deleted by an external magnetic field.

According to the embodiment, an event that the data recorded on the magnetic disk 16 is deleted by the influence of the external magnetic field can be prevented before it happens by employing the combination of the top cover 12 and the base 10 each formed of SPCC.

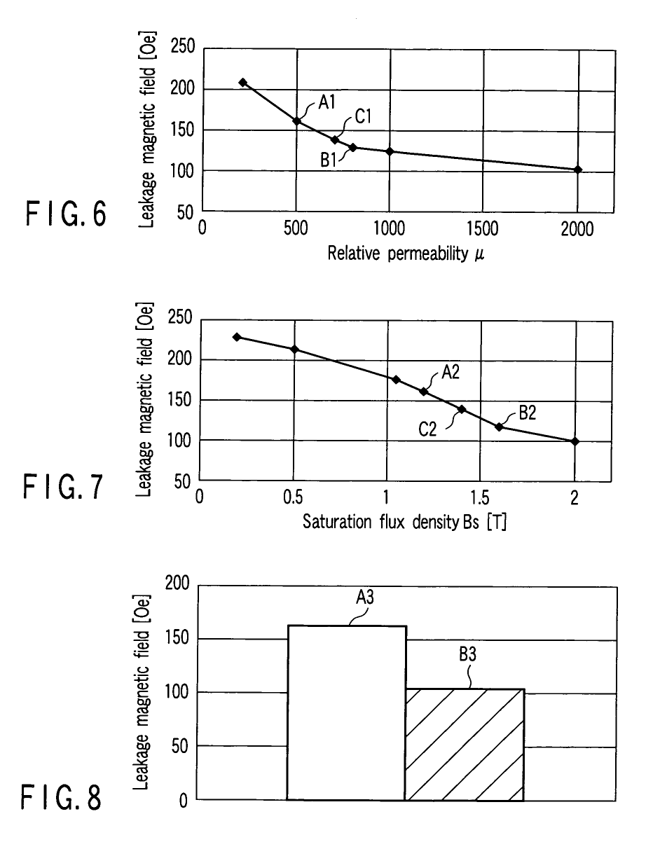

FIG. 6 shows a result of calculation carried out by a simulation for determining a relative permeability μ of the top cover 12. In this case, leakage magnetic field strength in the magnetic disk 16 is calculated by applying a uniform external magnetic field of 250 (Oe) as an external magnetic field, using Helmholtz coils or the like as the external magnetic field. Specifically, a leakage magnetic field is calculated using the permeability μ of the top cover 12 as a parameter.

The thickness of the case 11 is determined by the thickness of the top cover 12 set to 0.25 mm and the thickness of the base 10 set to 0.5 mm in which the magnetic shield effect is most weakened. The base 10 is formed of SPCC, has a saturation flux density Bs of 1.6 (T), and a relative permeability μ of 800. These values are calculated assuming that the bottom cover 15 is not attached.

According to the result of calculation, the limit of resistance to magnetic field of the magnetic heads 40 is 150 (Oe). However, since the SUS 430 with a relative permeability of 500 used in the 1.8 inch magnetic disk device employing an in-plane recording method has leakage magnetic field strength of 160 (Oe) as shown in A1 of FIG. 6, there is a possibility that the data recorded on the magnetic disk 16 may be deleted.

In contrast, when the base 10 and the top cover 12 each formed of SPCC with a relative permeability of 800 are used as in the embodiment, leakage magnetic field strength is 130 (Oe) as shown by B1 of FIG. 6, and thus, an event that the data recorded on the magnetic disk 16 is deleted by the influence of the external magnetic field can be prevented before it happens. Note that C1 of FIG. 6 shows a relative permeability of 700, and, in this case, leakage magnetic field strength is 130 (Qe). Accordingly, it is preferable that the base 10 and the top cover 12 have a relative permeability of 700 or more.

FIG. 7 shows a result of calculation carried out by a simulation for determining a saturated flux density Bs of the top cover 12. In this case, leakage magnetic field strength in the HDD is calculated by applying a uniform 250 (Oe) external magnetic field to the HDD using Helmholtz coils or the like as the external magnetic field. Specifically, a leakage magnetic field is calculated using the saturation flux density Bs of the top cover 12 as a parameter.

The thickness of the case 11 is determined by the thickness of the top cover 12 set to 0.25 mm and the thickness of the base 10 set to 0.5 mm in which the magnetic shield effect is most weakened. The base 10 is formed of SPCC, has a saturation flux density Bs of 1.6 (T), and a relative permeability μ of 800. These values are calculated assuming that the bottom cover 15 is not attached.

According to the result of calculation, the limit of resistance to magnetic field of the magnetic heads 40 is 150 (Qe). However, when the case is formed using the SUS 430 with a saturation flux density of 1.2 (T) employed in the 1.8 inch magnetic disk device employing the in-plane recording method, leakage magnetic field strength is 160 (Qe). Thus, there is a possibility that the data recorded on the magnetic disk 16 may be deleted.

However, according to the embodiment, when the base 10 and the top cover 12 are formed of SPCC with a saturation flux density of 1.6, leakage magnetic field strength is 117 (Qe) as shown by B2 of FIG. 7, and thus, an event that the data recorded on the magnetic disk 16 is deleted by the influence of the external magnetic field can be prevented before it happens. Note that C2 of FIG. 7 shows that the case 11 is formed of a material with a saturation flux density of 1.4 (T), and, in this case, leakage magnetic field strength is 139 (Qe). Accordingly, it is preferable that the base 10 and the top cover 12 have a saturation flux density of 1.4 (T) or more.

FIG. 8 shows a comparison between the leakage magnetic field strength A3 of the 1.8 inch magnetic disk device employing the in-plane recording method and the leakage magnetic field strength B3 of the HDD according to the present embodiment based on the result of examination described above. According to the result of examination, it can be confirmed that the leakage magnetic field strength is improved by about 60 (Oe) by forming the base 10 and the top cover 12 of SPCC. With this arrangement, an event that the data recorded on the magnetic disk 16 is deleted by the influence of the external magnetic field can be prevented before it happens.

In contrast, according to the embodiment, the gap between the surface of the magnetic disk 16 and the base 10 in the axial direction of the magnetic disk 16 is set to 0.35 mm or more, and the gap therebetween in the surface direction of the magnetic disk 16 is set to 0.5 mm or more. Further, the gap between the surface of the magnetic disk 16 and the top cover 12 in the axial direction of the magnetic disk 16 is set to 0.4 mm or more, and the gap therebetween along the surface direction of the magnetic disk 16 is set to 0.3 mm or more.

With this arrangement, a phenomenon that the magnetic domain structure of a backing soft magnetic layer constituting the magnetic disk 16 is disturbed and data recorded on the magnetic disk 16 is deleted by the influence of the external magnetic field can be prevented before it happens.

According to the embodiment, the bottom cover 15 is formed of a soft magnetic material and has a thickness of 0.1 mm or more. With this arrangement, the magnetic shield property of the HDD can be more improved.

According to the HDD arranged as described above, the phenomenon that data recorded on the magnetic disk 16 is deleted can be prevented by shielding the external magnetic field by the case 11 having the base 10 and the top cover 12. Since the writing performance of the HDD is improved by the improvement of the resistance to external magnetic field, there can be provided a highly reliable high recording density magnetic disk device employing the perpendicular magnetic recording method. Further, since it is not necessary to wind a magnetic shield member and the like around the outside surface of the case 11, the number of parts can be reduced and an assembling property can be improved as well as the thickness of the device can be more reduced in its entirety.

Since the base 10 and the top cover 12 can be engaged with each other being simultaneously sandwiched by both the side walls of the bottom cover 15, the bottom cover 15 can be fixed without using screws and dedicated support members. The effect due to external magnetic noise and electric field can be reduced by covering the overall back surface and the overall side walls of the HDD with the bottom cover 15.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, the number of the magnetic disk is not limited to one sheet and may be increased when necessary. Further, the material of the base, the top cover, and the bottom cover is not limited to the cold rolled carbon steel, and other soft magnetic material may be used.

What is claimed is:

1. A disk device comprising:
a case having a sheet-shaped base with an open upper surface formed of a soft magnetic material and a sheet-shaped top cover with an open upper surface formed of a soft magnetic material and attached to the base;
a disk-shaped recording medium which includes a substrate, a soft magnetic backing layer formed on the substrate, and a magnetic recording layer formed by being overlapped on the soft magnetic backing layer and having perpendicular magnetic anisotropy, the recording medium being arranged in the case; and
a mechanical unit including a head which carries out an information processing to the recording medium, a head actuator which supports the head, and a drive motor which supports and rotates the recording medium, the mechanical unit being arranged on the base,
the base having a thickness of 0.5 mm or more and the top cover having a thickness of 0.25 mm or more, respectively, and
the base and the top cover having a relative permeability of 700 or more and a saturation flux density of 1.4 (T) or more.

2. The disk device according to claim 1, wherein
a gap between the surface of the recording medium and the base in the axial direction of the recording medium is set to 0.35 mm or more, and a gap therebetween in the surface direction of the recording medium is set to 0.5 mm or more, and
a gap between the surface of the recording medium and the top cover in the axial direction of the recording medium is set to 0.4 mm or more, and a gap therebetween in the surface direction of the recording medium is set to 0.3 mm or more.

3. The disk device according to claim 1, wherein the base and the top cover includes peripheral edges which have abutment portions abutted against each other, respectively, and the widths of the abutment portions of the base and the top cover are formed larger than the thicknesses of the base and the top cover.

4. The disk device according to claim 3, wherein the base has a plurality of threaded holes formed in the abutment portion, the top cover has a plurality of projections formed at the abutment portion to oppose the threaded holes, projecting toward the base side, and abutted against the abutment portion of the base, and the projecting heights of the respective projections are set to 1 mm or less.

5. The disk device according to claim 1, further comprising: a sheet-shaped bottom cover located opposite to the top cover, the bottom cover covering the back surface of the base, and being formed of a soft magnetic material, and
wherein the base has a pair of side edges extending in parallel with each other,
the top cover has a pair of side edges overlapping the side edges of the base and extending in parallel with each other, and
the bottom cover has a pair of side walls which engages the side edges of the base with the side edges of the top cover by sandwiching them from the outside.

6. The disk device according to claim 5, further comprising: a printed circuit board arranged to face the base on an opposite side of the top cover; and
a connector mounted on the printed circuit board,
wherein the bottom cover is arranged to cover the printed circuit board.

7. The disk device according to claim 1, wherein the head includes: a main magnetic pole which applies a recording magnetic field to the recording medium; a return yoke to which a flux return path is formed; and a reproducing element which reads out a signal from the recording medium.
